(19) United States
(12) Patent Application Publication
(10) Pub. No.: US 2017/0205053 A1
(43) Pub. Date: Jul. 20, 2017

(54) SYSTEMS AND METHODS FOR MODULAR LIGHT FIXTURES

(71) Applicant: Orion Energy Systems, Inc., Manitowoc, WI (US)

(72) Inventors: Scott Green, Ponte Vedra Beach, FL (US); Matthew Tlachac, Manitowoc, WI (US); Paul Stegemann, Manitowoc, WI (US); John Scribante, Manitowoc, WI (US); Scott Lowden, Orange Park, FL (US); George Wilson, Middleburg, FL (US)

(73) Assignee: Orion Energy Systems, Inc., Manitowoc, WI (US)

(21) Appl. No.: 15/409,328

(22) Filed: Jan. 18, 2017

Related U.S. Application Data
(60) Provisional application No. 62/280,468, filed on Jan. 19, 2016.

(51) Int. Cl. F21V 17/06; F21V 3/02; F21V 7/00; F21S 8/04

(52) U.S. Cl. CPC F21V 17/06; F21S 8/043; F21V 3/02; F21V 7/005

(57) ABSTRACT

A light fixture includes a frame and a modular driver assembly. The frame includes one or more panels, a first end cap coupled to the one or more panels, the first end cap defining a first end of the frame, and a second end cap coupled to the one or more panels, the second end cap defining a second end of the frame opposite the first end. At least one of the one or more panels, the first end cap, and the second end cap at least partially define a receptacle. The modular driver assembly includes a lighting element and a mounting panel configured to selectively interface with the first end cap and the second end cap to support the modular driver assembly within the receptacle defined by the frame.

### CROSS-REFERENCE TO RELATED APPLICATIONS

This application claims the benefit of U.S. Provisional Patent Application No. 62/280,468, filed Jan. 19, 2016, which is incorporated herein by reference in its entirety.

### BACKGROUND

Light fixtures, such as those for interior lighting applications, include light sources secured to enclosures. The light sources may not be easily removable from the enclosure (e.g., secured using a number of fasteners and/or an adhesive, etc.). In some cases, the light sources are permanently affixed to the light fixture (e.g., welded, etc.). The light sources may contain various lighting elements [e.g., light-emitting diodes (LEDs), LED chips, metal Halide fixtures, fluorescent elements, etc.], which may be subject to failure during the useful life of the light fixture. Similarly, greater energy efficiency in the production of light can justify replacing an existing light source with a more efficient light source.

### SUMMARY

One embodiment relates to a light fixture that includes a frame and a modular driver assembly. The frame includes one or more panels, a first end cap coupled to the one or more panels, the first end cap defining a first end of the frame, and a second end cap coupled to the one or more panels, the second end cap defining a second end of the frame opposite the first end. At least one of the one or more panels, the first end cap, and the second end cap at least partially define a receptacle. The modular driver assembly includes a lighting element and a mounting panel configured to selectively interface with the first end cap and the second end cap to support the modular driver assembly within the receptacle defined by the frame.

Another embodiment relates to a modular driver assembly for a light fixture. The modular driver assembly includes a mounting panel having a first face, an opposing second face, a first end, and an opposing second end. The modular driver assembly further includes a lighting element (a) configured to provide illumination from the light fixture and (b) coupled to the first face of the mounting panel. The modular driver assembly further includes a driver operatively connected to the lighting element and at least selectively operatively connected to a power source, the driver configured to provide electrical energy to the lighting element from the power source. The driver is coupled to the opposing second face of the mounting panel. The first end and the opposing second end of the mounting panel are configured to interface with a frame of the light fixture without fasteners to selectively support the mounting panel, the lighting element, and the driver.

Another embodiment relates to a method of installing a modular driver assembly as part of a light fixture that includes connecting a driver of the modular driver assembly to a power source, the driver configured to provide electrical energy from the power source to a lighting element of the modular driver assembly, inserting a projection on a first end of the modular driver assembly into a slot in a first end cap of the light fixture, raising a second end of the modular driver assembly into a receptacle of the light fixture such that a portion of the second end contacts a latch of the light fixture, biasing the latch away from the second end, and resting the second end on a surface of the latch.

The invention is capable of other embodiments and of being carried out in various ways. Alternative exemplary embodiments relate to other features and combinations of features as may be recited herein.

### BRIEF DESCRIPTION OF THE DRAWINGS

The disclosure will become more fully understood from the following detailed description, taken in conjunction with the accompanying figures, wherein like reference numerals refer to like elements, in which:

FIG. 1 is a bottom view of a light fixture, according to an exemplary embodiment;

FIG. 2 is a top view of the light fixture shown in FIG. 1;

FIG. 3 is a side view of the light fixture shown in FIG. 1;

FIG. 4 is another side view of the light fixture shown in FIG. 1;

FIG. 5 is a bottom wire frame view of the light fixture shown in FIG. 1;

FIG. 6 is a top view of a frame for a light fixture, such as that shown in FIG. 1;

FIG. 7 is a bottom detail view of the frame shown in FIG. 6;

FIG. 8 is another bottom detail view the frame shown in FIG. 6;

FIG. 9 is another bottom detail view of the frame shown in FIG. 6;

FIG. 10 is a bottom view of a modular driver assembly for a light fixture, such as that shown in FIG. 1, according to an exemplary embodiment;

FIG. 11 is a top view of the modular driver assembly shown in FIG. 10;

FIG. 12 is a bottom view of the modular driver assembly shown in FIG. 10 without a lens;

FIG. 13 is a side perspective view of the modular driver assembly shown in FIG. 10;

FIG. 14 is a side detail view of the light fixture shown in FIG. 1;

FIG. 15 is another side detail view of the light fixture shown in FIG. 1;

FIG. 16 is another side detail view of the light fixture shown in FIG. 1;

FIG. 17 is another side detail view of the light fixture shown in FIG. 1;

FIG. 18 is another side detail view of the light fixture shown in FIG. 1;

FIG. 19 is a side detail wire frame view of the light fixture shown in FIG. 5;

FIG. 20 is another side detail wire frame view of the light fixture shown in FIG. 5;

FIG. 21 is a bottom wire frame view of a light fixture, according to an alternative embodiment;

FIG. 22 is a top perspective view of the light fixture shown in FIG. 21;

FIG. 23 is a bottom perspective view of the light fixture shown in FIG. 21;

FIG. 24 is a top detail view of the light fixture shown in FIG. 21;

FIG. 25 is another top detail view of the light fixture shown in FIG. 21;

FIG. 26 is a side view of a mounting bracket for a light fixture, such as that shown in FIG. 1, according to an exemplary embodiment;

FIG. 27 is another side detail view of the mounting bracket shown in FIG. 26.

### DETAILED DESCRIPTION

Before turning to the figures, which illustrate the exemplary embodiments in detail, it should be understood that the present application is not limited to the details or methodology set forth in the description or illustrated in the figures. It should also be understood that the terminology is for the purpose of description only and should not be regarded as limiting.

According to an exemplary embodiment, a light fixture (e.g., troffer, recessed troffer, commercial light, LED fixture, recessed light, high bay fixture, etc.) includes a frame (e.g., body, enclosure, unit, hub, etc.) and a modular driver assembly (e.g., modular assembly, central assembly, etc.). The modular driver assembly is releasably attached or secured to the frame (e.g., with a latch assembly and a retainer, etc.). The latch assembly and the retainer may be selectively repositionable on opposite sides of the modular driver assembly. The latch assembly may be selectively repositionable between an engaged position and a disengaged position. In the engaged position, the latch assembly may secure the modular driver assembly to the frame. In the disengaged position, the latch assembly may allow the modular driver assembly to be removed from the frame. In an installed position, the retainer may engage an interface of the frame and structurally couple the modular driver assembly to the frame. The modular driver assembly may be installed into and removed from the frame such that LEDs or other components or sources of light of the modular driver assembly may be replaced without requiring removal and/or replacement of the frame (e.g., replacement with newer equipment, to facilitate refurbishment, etc.). The frame may be installed as part of a retrofit or new installation process. The frame according to the invention is easily adaptable to differing installation schemes depending upon the circumstances. For example, in one embodiment, a licensed electrician can install the entire structure, the frame and the modular driver assembly. However, in an alternative situation, multiple workers with differing skill sets can be used. For example, a first installer (e.g., an apprentice, etc.) may install the frame, and which would later be followed up by a second installer (e.g., a licensed electrician, etc.) to install the modular driver assembly. The light fixture, having components designed to be installed by installers with different credentials, may result in reduced installation costs relative to single-element fixtures requiring installation completely by a licensed electrician.

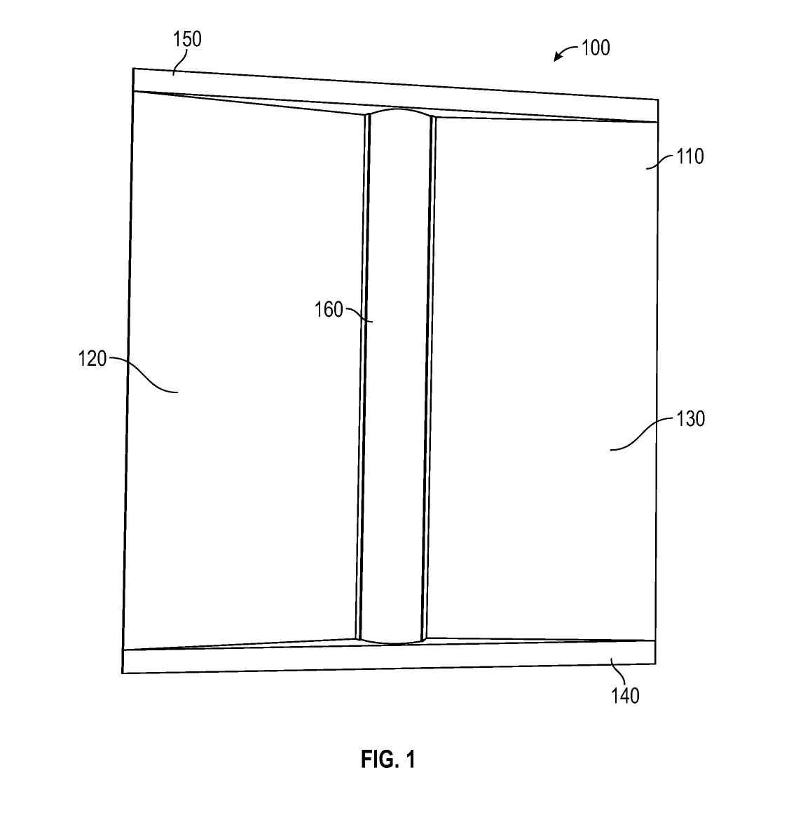

Referring to FIGS. 1-5, a light fixture (e.g., troffer, recessed troffer, commercial light, LED fixture, recessed light, high bay fixture, etc.), shown as light fixture 100, includes a frame (e.g., body, enclosure, unit, hub, etc.), shown as frame 110, and a modular driver assembly (e.g., modular assembly, central assembly, etc.), shown as modular driver assembly 200. While light fixture 100 is primarily illustrated as a commercial lighting fixture, it is to be understood that light fixture 100 may be suitable for residential, outdoor (e.g., area lighting, etc.), and/or industrial lighting (e.g., high bay lighting applications, etc.) as well. In some embodiments, light fixture 100 is a two foot by two foot troffer. In other embodiments, light fixture 100 is a two foot by four foot troffer. It is understood that the particular dimensions supplied above are only for illustrative purposes, light fixture 100 may have any shape, size, and/or configuration that is tailored for a target application.

As shown in FIG. 1, frame 110 includes a first panel (e.g., surface, member, etc.), shown as first reflecting panel 120, a second panel (e.g., surface, member, etc.), shown as second reflecting panel 130, a first end cap (e.g., cover, etc.), shown as latch end cap 140, and a second end cap (e.g., cover, etc.), shown as retainer end cap 150. First reflecting panel 120 and second reflecting panel 130 may be two or more separate pieces of material or may be integrally formed from a single piece of material that defines a single unitary body, according to various embodiments. In some embodiments, modular driver assembly 200 includes a lens (e.g., cover, etc.), shown as lens 160. In various embodiments, modular driver assembly 200 is positioned such that first reflecting panel 120 and second reflecting panel 130 are positioned on opposing lateral sides of modular driver assembly 200 and such that latch end cap 140 and retainer end cap 150 are positioned on opposing longitudinal ends of modular driver assembly 200.

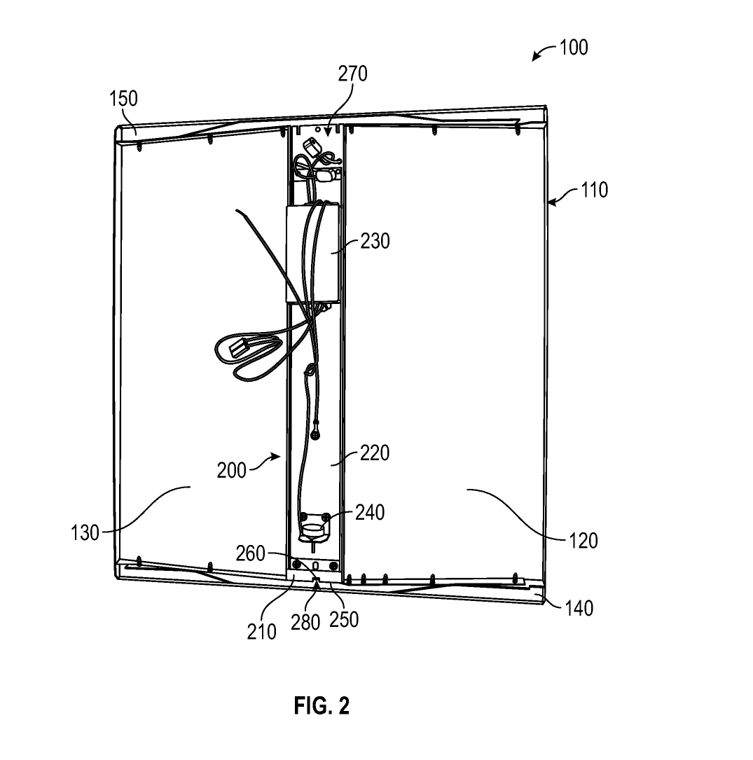

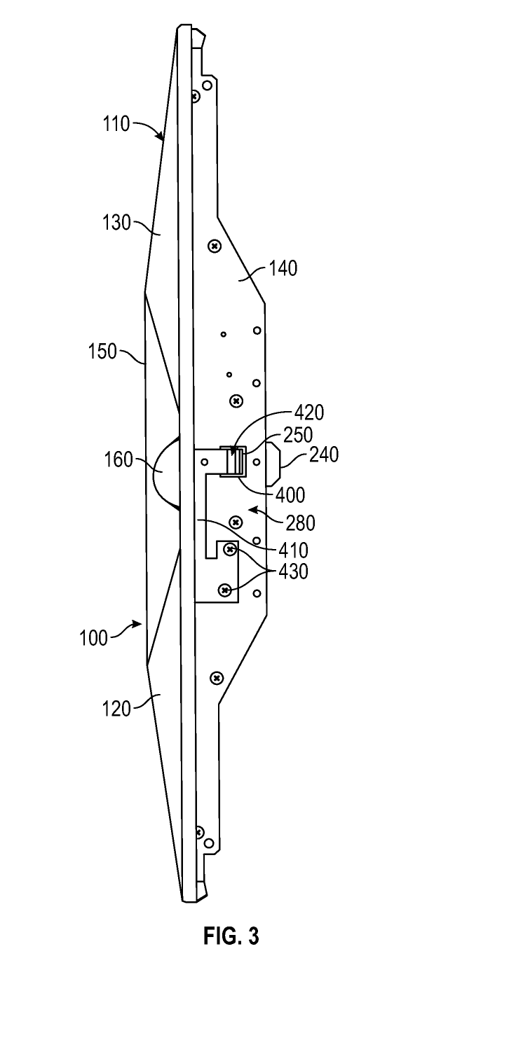

As shown in FIG. 2, modular driver assembly 200 includes a first panel (e.g., surface, member, etc.), shown as mounting panel 210, a second panel (e.g., surface, member, etc.), shown as ground panel 220, and a driver (e.g., an LED driver, etc.) shown as driver 230. As further shown in FIG. 2, modular driver assembly 200 includes a controller (e.g., modulator, etc.), shown as dimmer 240. According to the embodiment shown in FIG. 2, mounting panel 210 includes an edge (e.g., line, angle, bend, end, etc.), shown as latch edge 250, and a retainer (e.g., projection, protuberance, protrusion, etc.), shown as retainer 270. As shown in FIG. 3, modular driver assembly 200 is releasably coupled to frame 110 with a latch assembly (e.g., locking mechanism, securing mechanism, fastening mechanism, etc.), shown as latch assembly 280. Latch assembly 280 is coupled to frame 110. In other embodiments, modular driver assembly 200 is otherwise releasably coupled to frame 110.

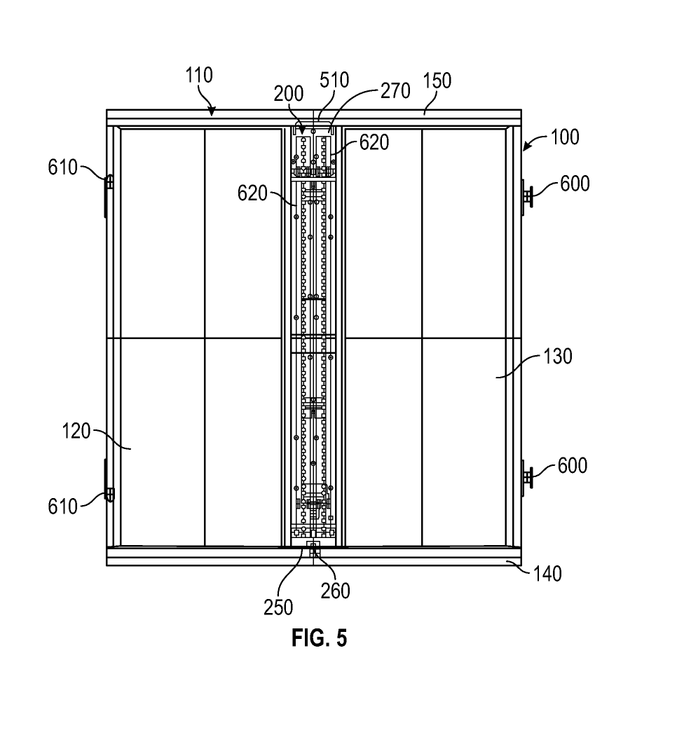

Modular driver assembly 200 may be configured to be electrically coupled to a power source (e.g., electrical source, outlet, etc.) such as a one-hundred and twenty volt power source. Modular driver assembly 200 may include a light source such as LEDs. Ground panel 220 may provide an electrical ground (e.g., earth, negative, etc.) for modular driver assembly 200. Driver 230 may be configured to power the one or more LEDs of modular driver assembly 200. Dimmer 240 may be coupled to driver 230 and may variably control an output (e.g., current, etc.) of driver 230. As shown in FIG. 5, Modular driver assembly 200 further includes a number of luminaires (e.g., lights, illuminators, LEDs, OLEDs, high powered LEDs, etc.), shown as LED modules 620. According to various embodiments, modular driver assembly 200 includes two LED modules 620. In alternative embodiments, modular driver assembly 200 includes three or more LED modules 620. In one embodiment, modular driver assembly 200 includes one LED module 620. Modular driver assembly 200 may be electrically coupled and/or structurally coupled to LED modules 620. In various embodiments, driver 230 and ground panel 220 are electrically coupled to LED modules 620. LED modules 620 may be secured to modular driver assembly 200 with fasteners (e.g., fasteners 430, etc.), adhesives, etc. Bracket hinge 600 and/or bracket latch 610 may secure (e.g., fasten, mount, attach, etc.) light fixture 100 to a mounting bracket. For example, bracket hinge 600 and bracket latch 610 may allow light fixture 100 to be retrofit installed into a T-bar ceiling system, such as that common in office ceilings. One example of a bracket, hinge, and/or latch suitable for use according to this invention is seen in U.S. Pat. No. 9,206,948, which is expressly incorporated herein by reference.

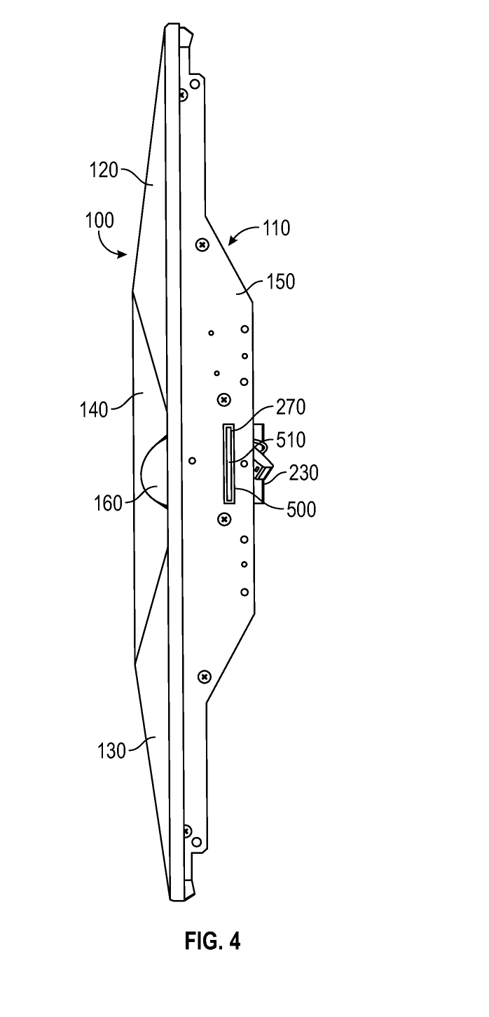

Latch assembly 280 includes a bias (e.g., structure, etc.), shown as resilient member 410, and a projection (e.g., protuberance, protrusion, lock, prong, tang, etc.), shown as latch 420. Referring specifically to FIG. 3, latch end cap 140 defines an aperture (e.g., port, etc.), shown as aperture 400, that receives latch 420. Latch assembly 280 may be secured (e.g., retained, secured, attached, affixed, etc.) to latch end cap 140 with fasteners (e.g., screws, bolts, rivets, etc.), shown as fasteners 430. According to various embodiments, aperture 400 that receives latch 420 is sized to receive (e.g., accept, etc.) latch 420. As shown in FIG. 4, retainer end cap 150 defines an interface configured to engage retainer 270 and facilitate securing modular driver assembly 200. As shown in FIG. 4, the interface defines an aperture (e.g., port, etc.), shown as aperture 500. Retainer 270 may be inserted into aperture 500 when modular driver assembly 200 is installed in light fixture 100, and an edge of retainer 270, shown as retainer edge 510, may protrude through aperture 500. In some embodiments, retainer 270 is a tabbed projection and aperture 500 is a slot sized to receive retainer 270. In various embodiments, aperture 500 is substantially aligned with retainer 270.

According to various embodiments, aperture 500 is sized to receive (e.g., accept, etc.) retainer edge 510. In some embodiments, retainer 270 is aligned with latch 420. In alternative embodiments, retainer 270 is offset from latch 420 a target distance and/or angle. In one embodiment, resilient member 410 is secured (e.g., fastened, attached, etc.) to latch end cap 140 in a static position through the use of fasteners 430. In various embodiments, when resilient member 410 is selectively repositioned from the static position, resilient member 410 is biased towards the static position by a spring force. Resilient member 410 may have a configuration, shape, and/or position selected to provide a target spring force. In some embodiments, the spring force is a function of the material of resilient member 410. In the static position, resilient member 410 may not be subject to a biasing force.

Referring to FIG. 5, frame 110 further includes a first interface (e.g., protuberance, protrusion, lock, prong, tang, etc.), shown as bracket hinge 600, and a second interface (e.g., protuberance, protrusion, lock, prong, tang, etc.), shown as bracket latch 610.

Current lighting fixtures do not allow a user to easily or readily upgrade the lighting fixture to the newest hardware available (e.g., LEDs) and/or allow a user to replace only the light system of the light fixture in the event of a failure. As a result, users of current lighting fixtures must either opt to (a) replace the entire lighting fixture, (b) remove the fixture entirely to replace a component thereof, or (c) service the fixture in-situ. Light fixture 100 facilitates a user upgrade of light fixture 100 at a relatively low cost and in a relatively short amount of time. For example, a user may wish to increase the performance or energy efficiency of light fixture 100. By removing modular driver assembly 200, a user may install upgraded LED modules 620. The user may either replace modular driver assembly 200, or the user may replace individual components of modular driver assembly 200 such as driver 230, dimmer 240, and individual LED modules 620 without removing or replacing the entire light fixture 100 or wiring components thereof.

Typically, replacing an inoperable light source within a light fixture is difficult or impossible to achieve without replacing the entire light fixture. For example, the removal of multiple fasteners in various locations, in addition to disconnection and subsequent rewiring, may be required to remove a light source from current light fixtures. The LEDs installed in a light fixture upon purchase may become undesirable after a period of time due to the rapid rate at which new LEDs are introduced.

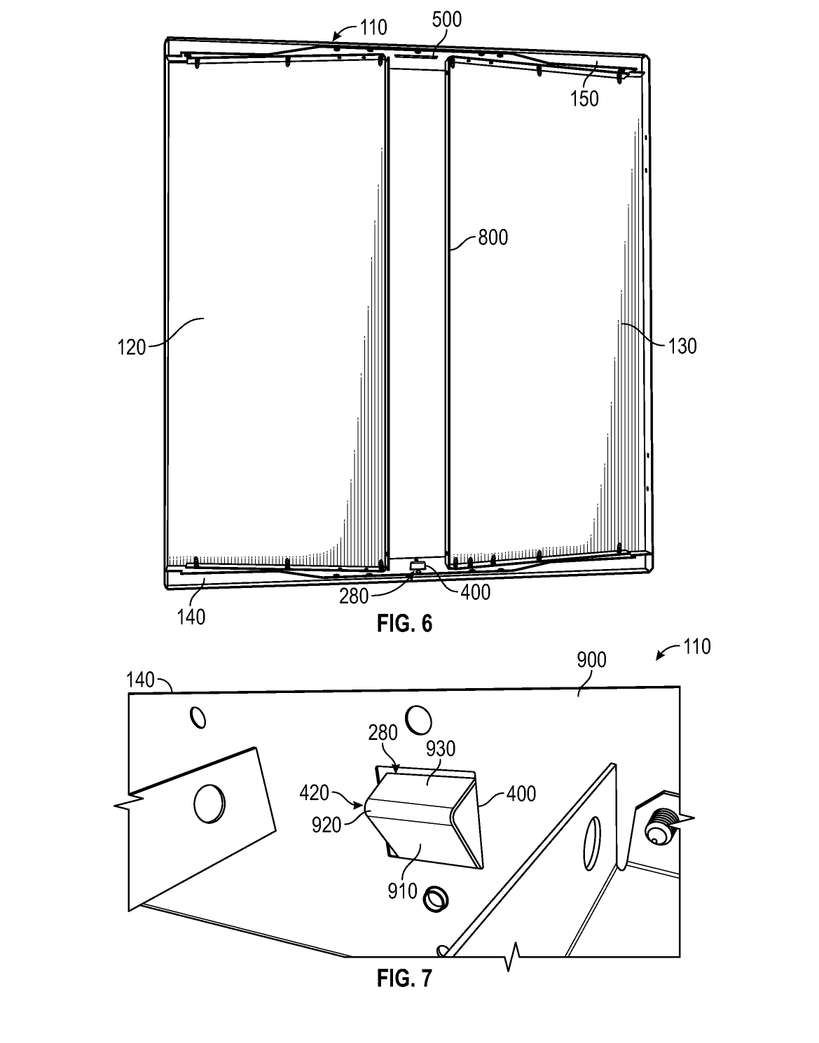

As shown in FIG. 6, frame 110 defines a receptacle (e.g., zone, area, etc.), shown as receptacle 800. In one embodiment, receptacle 800 is defined by first reflecting panel 120, second reflecting panel 130, retainer end cap 150, and latch end cap 140. Receptacle 800 of frame 110 is configured to receive modular driver assembly 200. Receptacle 800 may be made larger or smaller by altering the shapes, sizes, and/or configurations of first reflecting panel 120, second reflecting panel 130, retainer end cap 150, and latch end cap 140. For instance, it may be desirable for light fixture 100 to incorporate a larger modular driver assembly 200 such that a larger driver 230 and/or more LED modules 620 may be incorporated into light fixture 100.

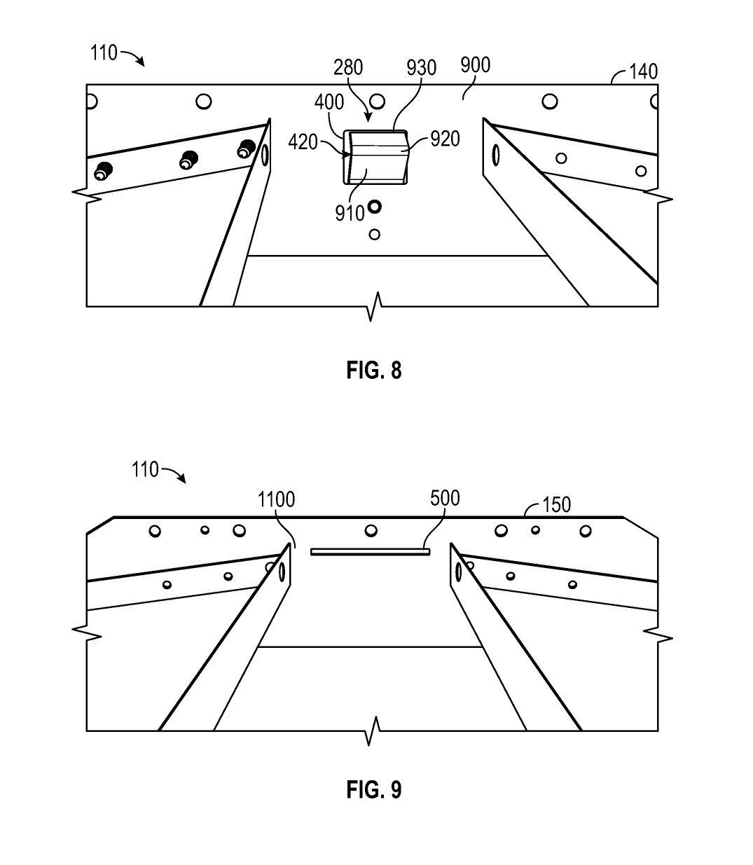

Referring to FIGS. 7 and 8, latch end cap 140 is shown to further include a surface (e.g., plane, face, etc.), shown as interior surface 900. Interior surface 900 may be in confronting relation with modular driver assembly 200. In some embodiments, interior surface 900 is in contact with modular driver assembly 200.

According to the embodiments shown in FIGS. 7 and 8, latch 420 includes a first surface (e.g., plane, face, etc.), shown as interface surface 910, an edge (e.g., corner, bend, etc.), shown as latch edge 920, and a second surface (e.g., plane, face, etc.), shown as support surface 930. Latch 420 may be selectively repositionable (e.g., movable, etc.) through aperture 400 that receives latch 420. Latch edge 920 may be defined as the union between interface surface 910 and support surface 930. In some embodiments, support surface 930 is angularly offset relative to interface surface 910. For example, interface surface 910 may be angularly offset sixty degrees from support surface 930. In various embodiments, aperture 400 is substantially aligned with latch 420.

According to the embodiment shown in FIG. 9, retainer end cap 150 defines a surface (e.g., plane, face, etc.), shown as interior surface 1100, in confronting relation with modular driver assembly 200. In some embodiments, interior surface 1100 is in contact with modular driver assembly 200. The shape, size, and configuration of aperture 500 may correspond to the shape, size, and configuration of retainer 270.

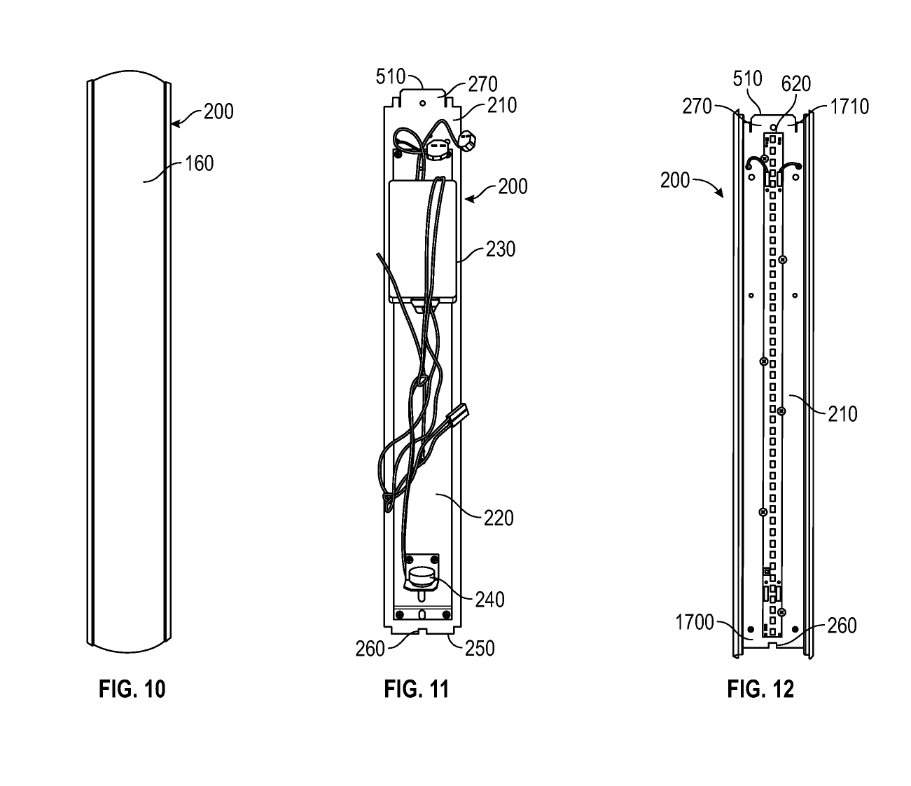

Referring to FIGS. 10-13, modular driver assembly 200 is shown removed from light fixture 100. Modular driver assembly 200 may be replaced and/or serviced once removed without removal of the entire light fixture 100. Servicing of modular driver assembly 200 need not occur while installed within a ceiling system. Modular driver assembly 200 may be upgraded and/or replaced (e.g., interchange, etc.) to upgrade and/or replace LED modules 620. In these cases, modular driver assembly 200 may be removed, and LED modules 620 may be upgraded and/or replaced, or a new modular driver assembly 200 may be installed. Modular driver assembly 200 is thereby modular within light fixture 100.

Mounting panel 210 may further include an aperture (e.g., slot, hole, port, access, etc.) shown as latch access 260. In some embodiments, mounting panel 210 does not include latch access 260. Latch access 260 may be configured to receive an implement such as a screwdriver. Modular driver assembly 200 may include a single LED module 620. In some embodiments, LED module 620 is configured to be positioned along a centerline of modular driver assembly 200.

According to various embodiments, lens 160 is removable from modular driver assembly 200. For example, lens 160 may be flexible, and lens 160 may be manipulated (e.g., bent, folded, pulled, pushed, etc.) and removed from modular driver assembly 200. In some embodiments, lens 160 is removable from modular driver assembly 200 even when modular driver assembly 200 is installed in light fixture 100 thereby facilitating access to various components of modular driver assembly 200 (e.g., latch access 260 and LED module 620, etc.). For example, a user may remove lens 160 from modular driver assembly 200 when modular driver assembly 200 is installed in light fixture 100 to replace and/or service LED module 620.

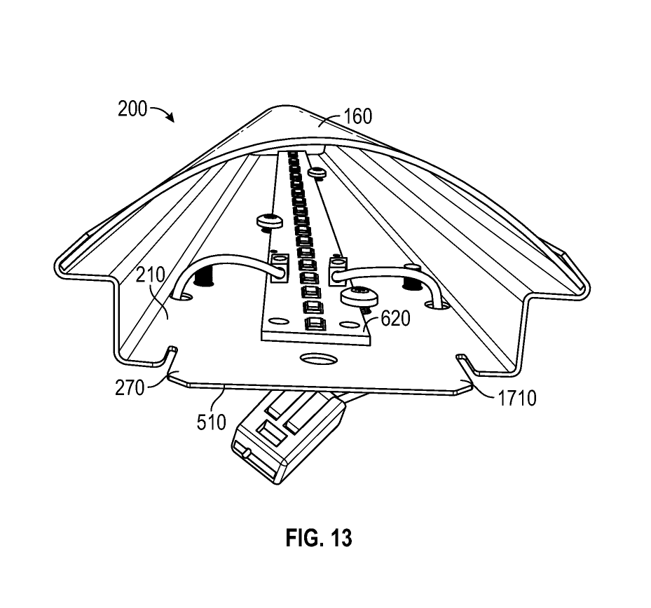

As shown in FIG. 12, modular driver assembly 200 defines a first surface (e.g., plane, face, etc.), shown as latch surface 1700, and a second surface (e.g., plane, face, etc.), shown as retainer surface 1710. In some embodiments, latch surface 1700 and retainer surface 1710 are coplanar. Retainer surface 1710 may contact an edge of aperture 500 when modular driver assembly 200 is installed in light fixture 100 and as modular driver assembly 200 is removed from light fixture 100.

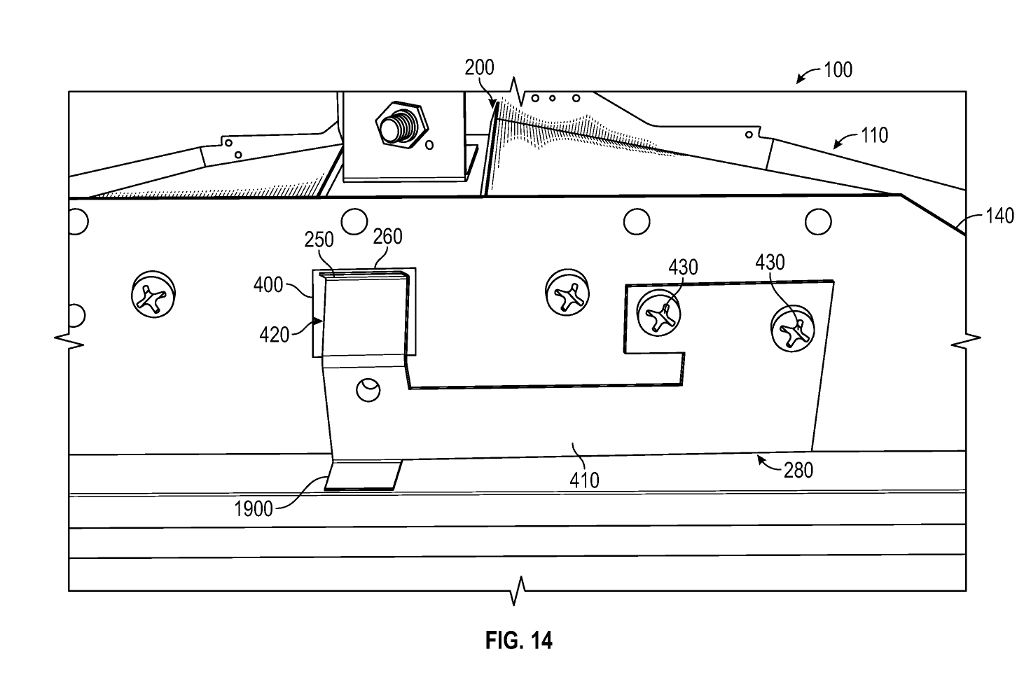

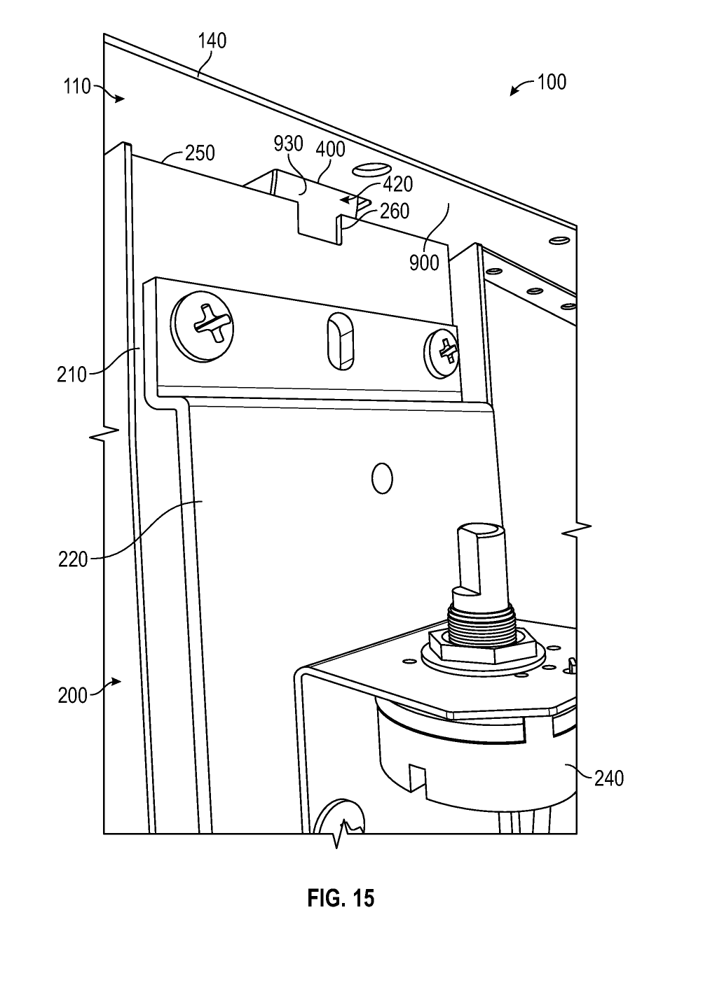

FIGS. 14-16 illustrate various interactions between latch assembly 280 and modular driver assembly 200. According to various embodiments, latch assembly 280 is selectively reconfigurable between an engaged position and a disengaged position. In some embodiments, latch 420 protrudes through aperture 400 and is in contact with latch surface 1700 when latch assembly 280 is in the engaged position. Latch 420 does not protrude through aperture 400 and is not in contact with latch surface 1700 when latch assembly 280 is in the disengaged position, according to one embodiment. In various embodiments, when in the engaged position, latch assembly 280 couples frame 110 (e.g., latch end cap 140, etc.) to modular driver assembly 200. When latch assembly 280 is in the disengaged position, latch assembly 280, frame 110, and modular driver assembly 200 may be at least partially decoupled. As shown in FIG. 14, latch assembly 280 further includes a guide (e.g., panel, plate, face, etc.), shown as guide 1900. In various embodiments, guide 1900 is configured to provide support to latch assembly 280. Guide 1900 may or may not contact frame 110. As latch assembly 280 moves between the engaged position and the disengaged position, guide 1900 may contact frame 110 and provide support to latch assembly 280. As shown in FIG. 15, latch 420 is at least partially positioned over latch access 260 when latch assembly 280 is in the engaged position.

According the embodiment shown in FIGS. 14 and 15, support surface 930 of latch 420 is in contact with latch surface 1700 and/or latch edge 250 when latch assembly 280 is in the engaged position. As latch assembly 280 transitions between the engaged position and the disengaged position, interface surface 910, latch edge 920, and support surface 930 may be in contact with latch surface 1700 and/or latch edge 250. In various embodiments, interface surface 910 and latch edge 920 may be in contact with latch surface 1700 and/or latch edge 250 when latch assembly 280 is in the disengaged position. In operation, a user may disengage latch assembly 280 by optionally first removing lens 160 from modular driver assembly 200 and thereafter inserting an implement (e.g., screwdriver, etc.) into latch access 260 such that the implement is in contact with interface surface 910 and/or latch edge 920. The user may then apply a force through the implement on interface surface 910, moving latch 420 into the disengaged position, and then remove modular driver assembly 200 from light fixture 100 while simultaneously removing the implement from latch access 260.

In other embodiments, latch assembly 280 additionally or alternatively includes another device. Resilient member 410 may be replaced by a spring or other biasing element that is coupled to latch 420 and frame 110. In other embodiments, the bias provided by resilient member 410 is replaced or supplemented by a spring mechanism. For example, the spring mechanism may be coupled to resilient member 410 and frame 110 and configured to bias resilient member 410 towards the static position.

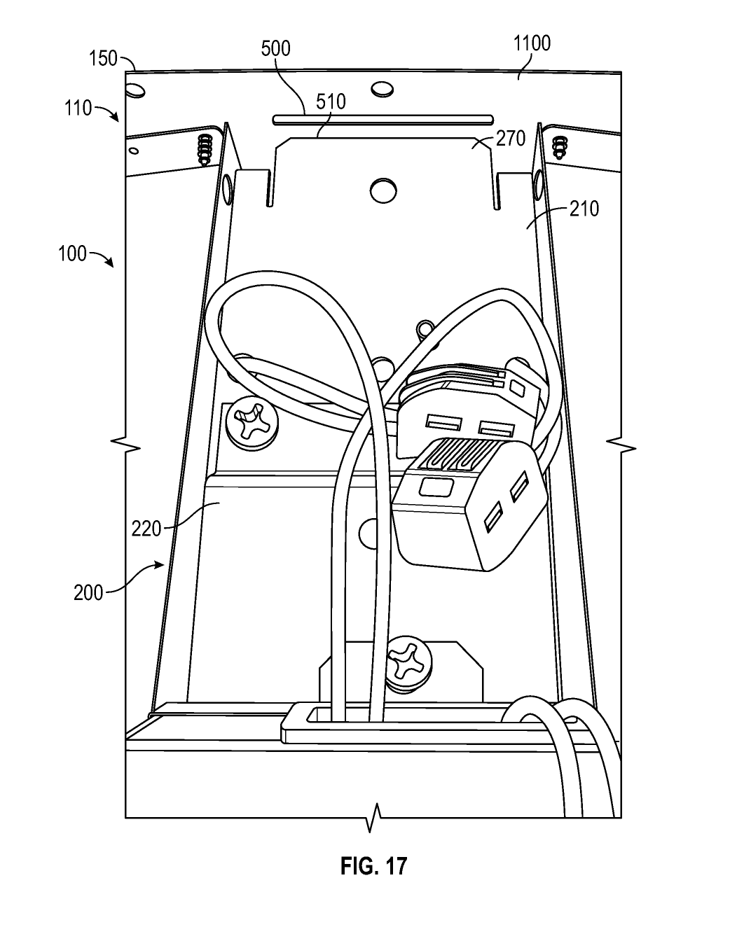

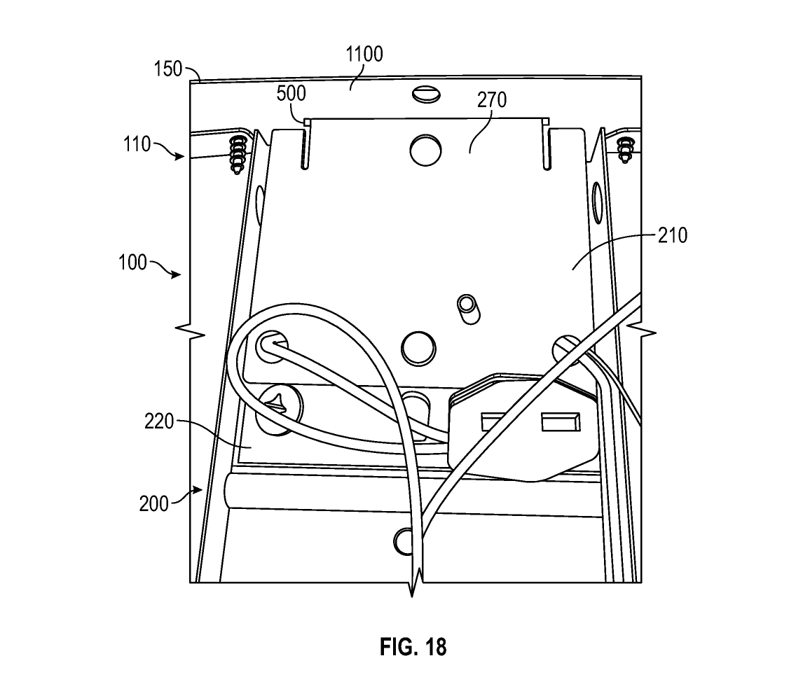

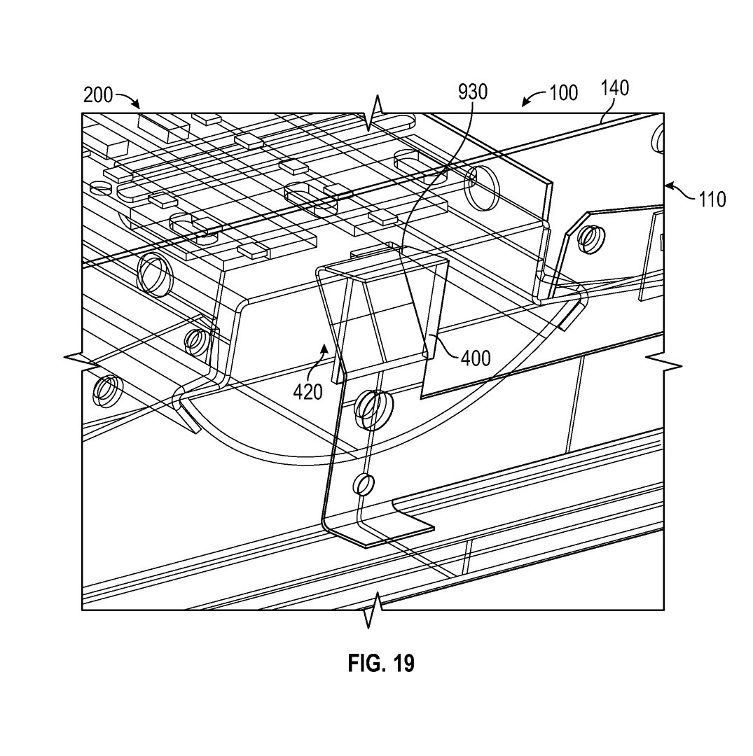

Referring to FIGS. 17 and 18, interactions between retainer 270 and retainer end cap 150 are shown. In various embodiments, retainer 270 is operable between an installed (e.g., inserted, etc.) position and an uninstalled (e.g., withdrawn, etc.) position. In the installed position, retainer 270 may protrude through a portion of retainer end cap 150 and at least partially couples modular driver assembly 200 to frame 110. In the uninstalled position, retainer 270 may not protrude through a portion of retainer end cap 150 and may not couple modular driver assembly 200 to frame 110. In some embodiments, retainer edge 510 protrudes through aperture 500 when retainer 270 is in the installed position. According to various embodiments, modular driver assembly 200 is supported by retainer end cap 150 when retainer 270 is in the installed position. In operation, modular driver assembly 200 is supported by an interaction between latch 420 and latch surface 1700 and an interaction between an edge of aperture 500 and retainer surface 1710. When removing modular driver assembly 200 from light fixture 100, a user may disengage latch assembly 280, remove the latch side of modular driver assembly 200, and then may remove retainer edge 510 from aperture 500. Similarly, to install modular driver assembly 200 into light fixture 100, the user may first insert retainer 270 (e.g., retainer edge 510, etc.) into aperture 500 such that retainer 270 is in the installed position and then press mounting panel 210 into latch 420 such that latch 420 pivots back and thereafter springs forward to protrude through aperture 400, in contact with latch surface 1700. When installing or removing modular driver assembly 200, retainer 270 may contact interior surface 1100. According to an exemplary embodiment, modular driver assembly 200 is releasably attached (e.g., coupled, fixed, etc.) to frame 110 through the use of latch assembly 280 and retainer 270.

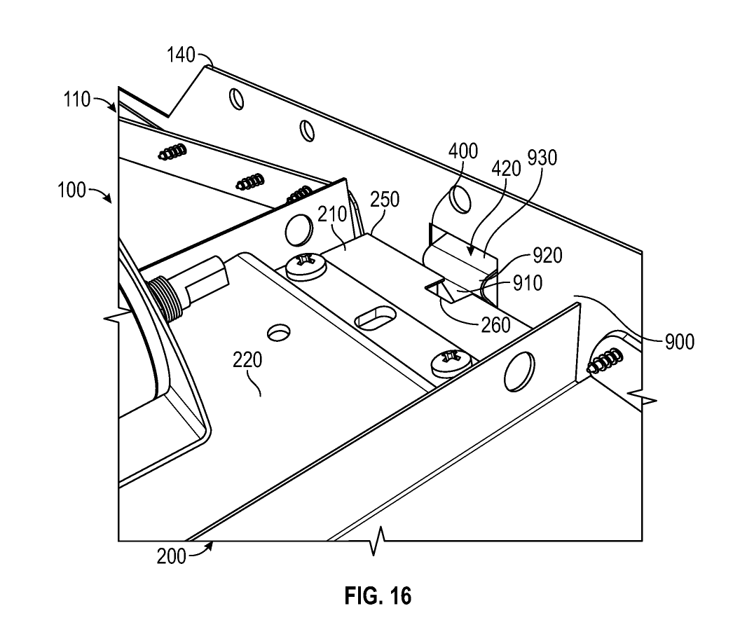

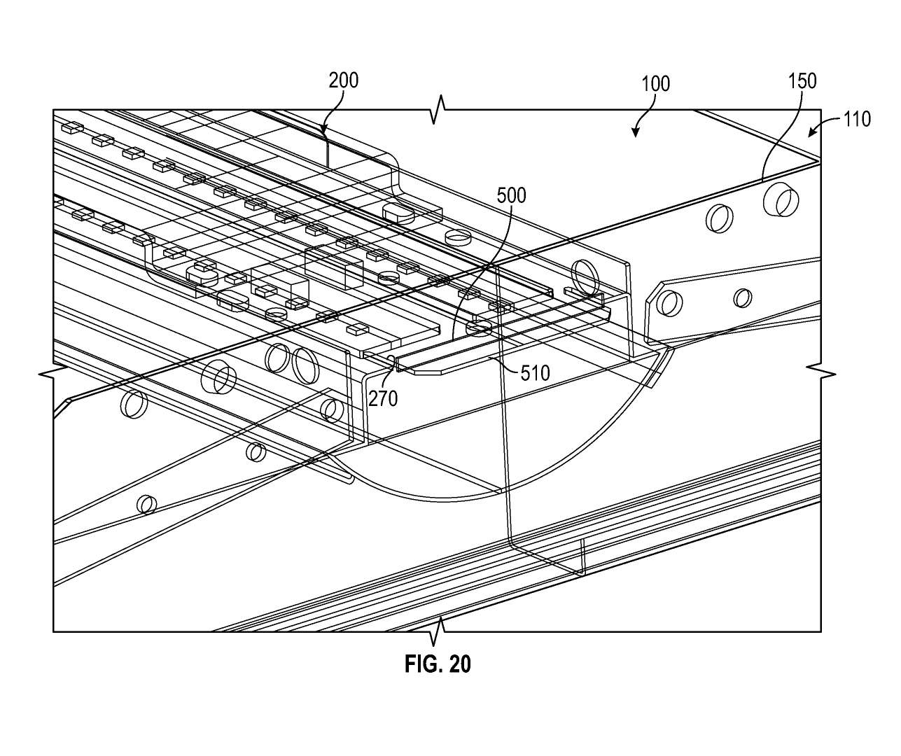

As shown in FIG. 16, latch assembly 280 is in the engaged position and supports modular driver assembly 200 in light fixture 100. According to various embodiments, support surface 930 is in contact with latch surface 1700 when modular driver assembly 200 is installed in light fixture 100. As shown in FIG. 20, retainer 270 is in the installed position (e.g., installed in retainer end cap 150). In various embodiments, retainer surface 1710 is in contact with an edge of aperture 500 when modular driver assembly 200 is installed in light fixture 100.

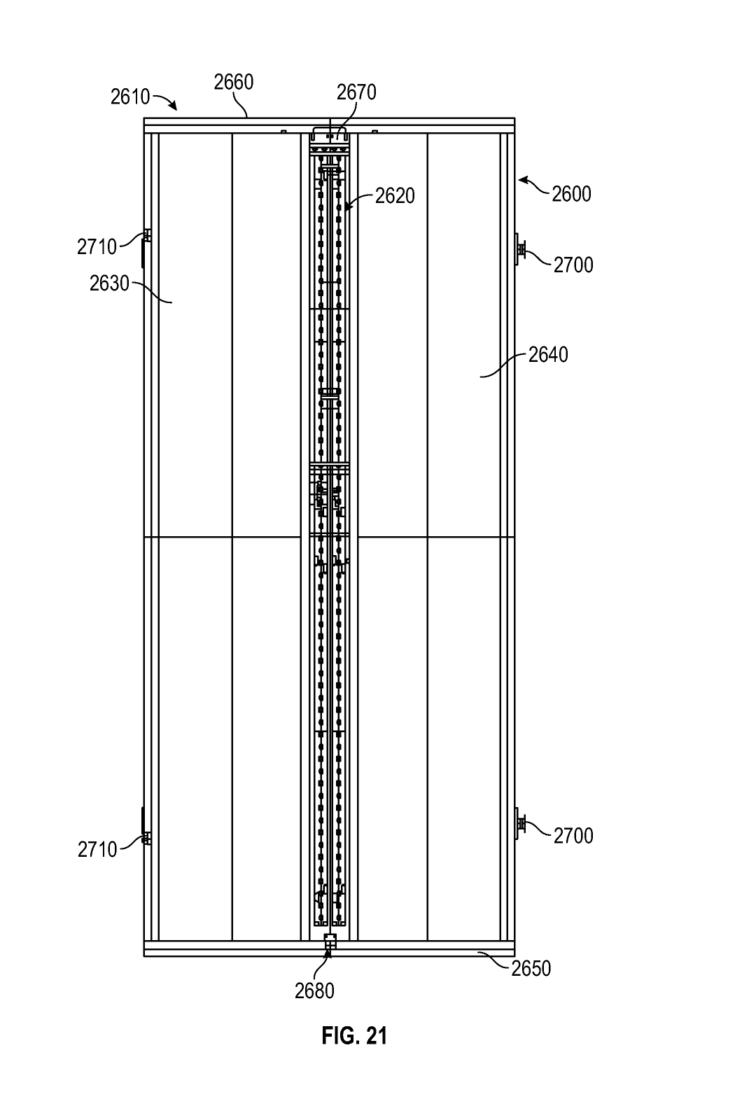

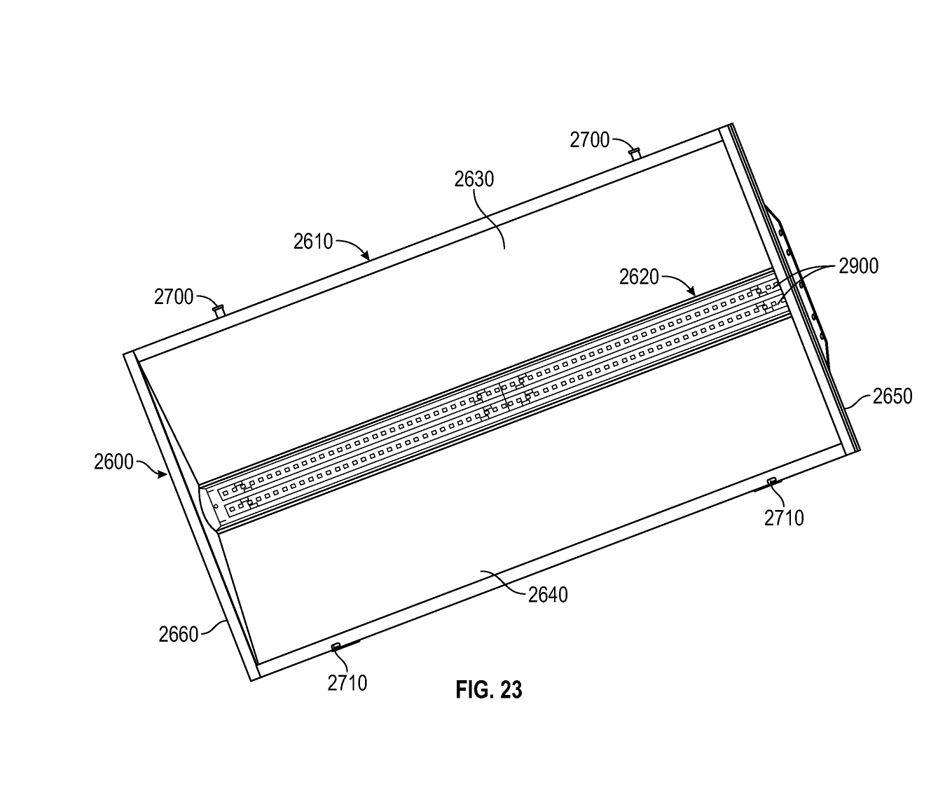

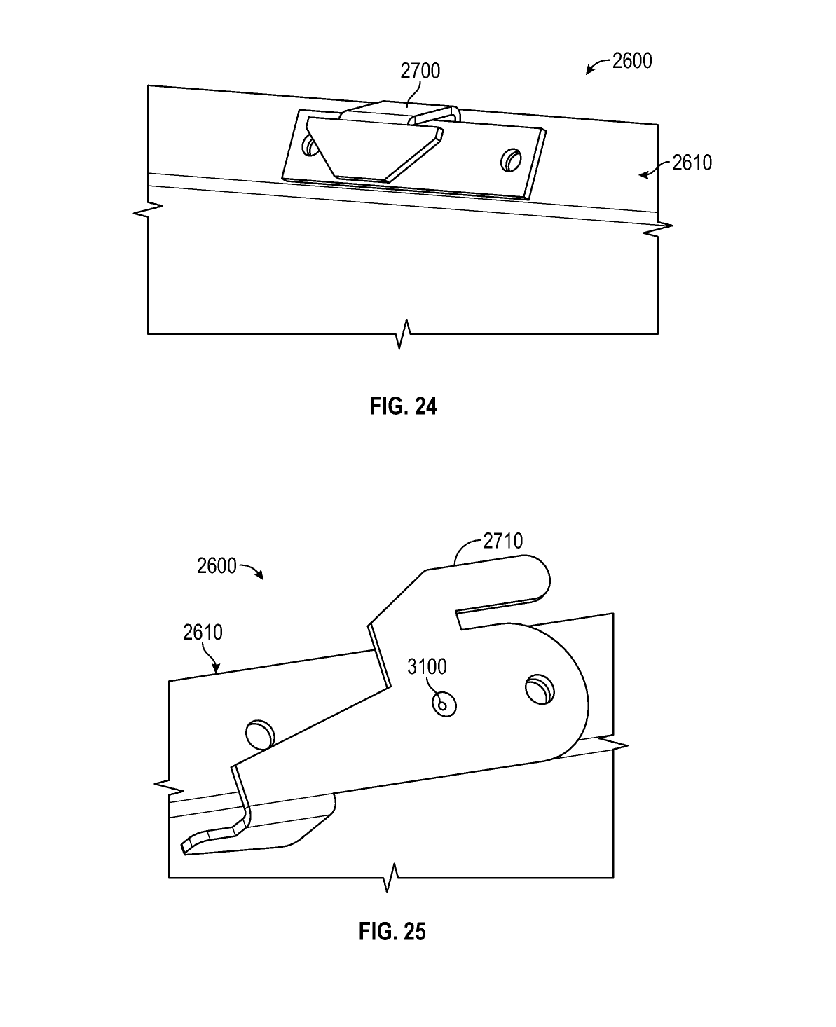

Referring to FIGS. 21-25, a light fixture (e.g., troffer, recessed troffer, commercial light, LED fixture, recessed light, high bay, etc.), shown as light fixture 2600 is shown. In various embodiments, light fixture 2600 differs from light fixture 100 only in size (e.g., length, width, etc.). It is understood that the description of light fixture 100 similarly applies to light fixture 2600. In some embodiments, light fixture 2600 is a two foot by four foot troffer light fixture. As shown in FIGS. 21-25, light fixture 2600 includes a frame (e.g., body, enclosure, unit, hub, etc.), shown as frame 2610, and a modular driver assembly (e.g., modular assembly, central assembly, etc.), shown as modular driver assembly 2620. As shown in FIG. 21, frame 2610 includes a first panel (e.g., surface, member, etc.), shown as first reflecting panel 2630, a second panel (e.g., surface, member, etc.), shown as second reflecting panel 2640, a first end cap (e.g., cover, etc.), shown as latch end cap 2650, and a second end cap (e.g., cover, etc.), shown as retainer end cap 2660. First reflecting panel 2630 and second reflecting panel 2640 may be two or more separate pieces of material or may be integrally formed from a single piece of material that defines a single unitary body, according to various embodiments. It is understood that light fixture 2600 may include similar components to those of light fixture 100.

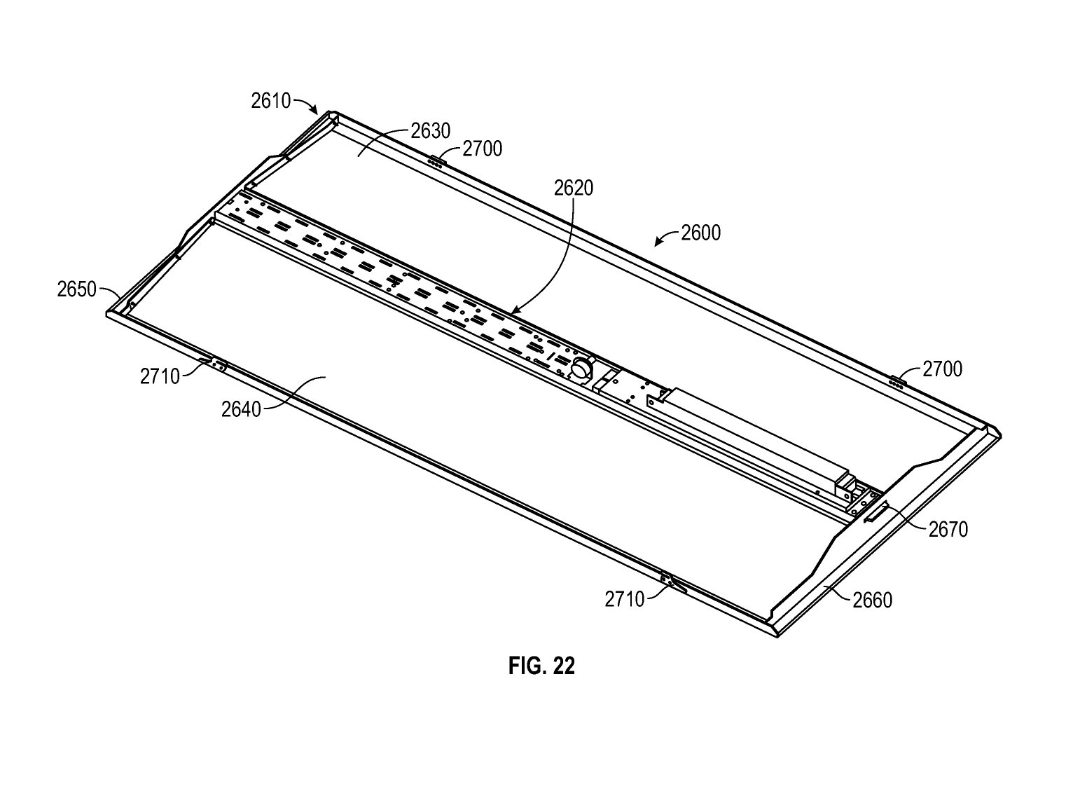

In various embodiments, modular driver assembly 2620 is positioned such that first reflecting panel 2630 and second reflecting panel 2640 are positioned on opposing lateral sides of modular driver assembly 2620 and such that latch end cap 2650 and retainer end cap 2660 are positioned on opposing longitudinal ends of modular driver assembly 2620. According to various embodiments, modular driver assembly 2620 includes a retainer (e.g., projection, protuberance, protrusion, etc.), shown as retainer 2670. As shown in FIG. 22, modular driver assembly 2620 is releasably coupled to frame 2610 with a latch assembly (e.g., locking mechanism, securing mechanism, fastening mechanism, etc.), shown as latch assembly 2680. Latch assembly 2680 may be selectively reconfigurable between an engaged position and a disengaged position. Retainer 2670 may be selectively repositionable between an installed position and an uninstalled position. Modular driver assembly 2620 includes a light source such as LEDs. As shown in FIG. 22, light fixture 2600 further includes a number of luminaires (e.g., lights, illuminators, LEDs, OLEDs, high powered LEDs, etc.), shown as LED modules 2900.

In various embodiments, light fixture 2600 further includes a first interface (e.g., protuberance, protrusion, lock, prong, tang, etc.), shown as bracket hinge 2700, and a second interface (e.g., protuberance, protrusion, lock, prong, tang, etc.), shown as bracket latch 2710. Bracket hinge 2700 and/or bracket latch 2710 may secure (e.g., fasten, mount, attach, etc.) light fixture 2600 to a mounting surface. For example, bracket hinge 2700 and bracket latch 2710 may allow light fixture 2600 to be retrofit installed into a T-bar ceiling system such as that common in office ceilings. Bracket hinge 2700 may be identical to bracket hinge 600. In some embodiments, light fixture 100 includes bracket hinge 2700 in place of or in addition to bracket hinge 600. Bracket latch 2710 may be identical to bracket latch 610. In some embodiments, light fixture 100 includes bracket latch 2710 in place of or in addition to bracket latch 610. As shown in FIG. 25, bracket latch 2710 is rotatable about a pivot (e.g., point, axis of rotation, etc.), shown as pivot 3100. According to various embodiments, bracket latch 2710 is pivotable about pivot 3100 between an engaged position and a disengaged position. In the engaged position, bracket latch 2710

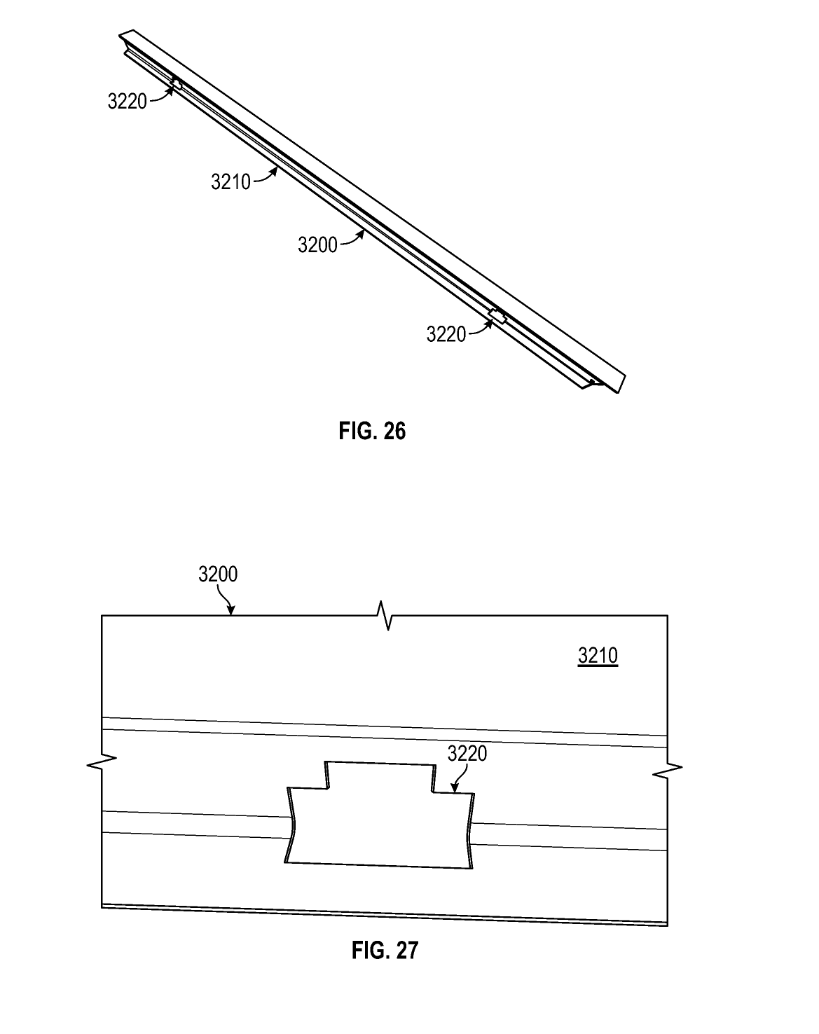

Referring to FIGS. 26 and 27, a mounting system (e.g., bracket, rail, etc.), shown as mounting bracket 3200, for a light fixture (e.g., light fixture 100, light fixture 2600, etc.) is shown. Mounting bracket 3200 may include a channel (e.g., track, etc.), shown as mounting channel 3210, and a number of apertures (e.g., ports, accesses, slots, holes, etc.), shown as apertures 3220. In some embodiments, mounting bracket 3200 includes two apertures 3220. According to various embodiments, mounting bracket 3200 is configured to couple a light fixture (e.g., light fixture 100, light fixture 2600, etc.) to a T-bar ceiling system. In some embodiments, apertures 3220 are configured to receive bracket hinge 600 and/or bracket hinge 2700. According to various embodiments, apertures 3220 are configured to receive bracket latch 610 and/or bracket latch 2710. In one embodiment, apertures 3220 are configured to receive both bracket hinges and bracket latches.

Mounting bracket 3200 may have a length corresponding to a dimension (e.g., length, width, etc.) of a light fixture (e.g., light fixture 100, light fixture 2600, etc.). Mounting bracket 3200 may be sized to receive a portion of a light fixture (e.g., light fixture 100, light fixture 2600) and configured to thereby support the light fixture. For example, in some embodiments, mounting channel 3210 is sized to receive light fixture 100 and configured to support light fixture 100. In other embodiments, mounting channel 3210 is sized to receive light fixture 2600 and configured to support light fixture 2600. In various applications, mounting bracket 3200 may rest upon a T-bar ceiling system to facilitate a retrofit installation.

According to various embodiments, light fixture 100 and light fixture 2600 are powered by a main power supply. In these embodiments, the main power supply is an alternating current power having a voltage of between one-hundred and twenty Volts and two-hundred and seventy-seven Volts.

It is to be understood that the term fastener may include any suitable fastening device, mechanism, or component. Likewise, it is to be understood that the term hole may include any suitable aperture for a corresponding fastening device. According to an exemplary embodiment, fasteners are thread forming screws which are configured to interact with the material of light fixture 100 or light fixture 2600 to form threads to secure the fasteners to light fixture 100 or light fixture 2600, respectively.

The construction and arrangement of the apparatus, systems and methods as shown in the various exemplary embodiments are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.). For example, some elements shown as integrally formed may be constructed from multiple parts or elements, the position of elements may be reversed or otherwise varied and the nature or number of discrete elements or positions may be altered or varied. Accordingly, all such modifications are intended to be included within the scope of the present disclosure. The order or sequence of any process or method steps may be varied or re-sequenced according to alternative embodiments. Other substitutions, modifications, changes, and omissions may be made in the design, operating conditions and arrangement of the exemplary embodiments without departing from the scope of the present disclosure.

As utilized herein, the terms “approximately,” “about,” “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the invention as recited in the appended claims.

It should be noted that the term “exemplary” as used herein to describe various embodiments is intended to indicate that such embodiments are possible examples, representations, and/or illustrations of possible embodiments (and such term is not intended to connote that such embodiments are necessarily extraordinary or superlative examples).

The terms “coupled,” “connected,” and the like as used herein mean the joining of two members directly or indirectly to one another. Such joining may be stationary (e.g., permanent) or moveable (e.g., removable or releasable). Such joining may be achieved with the two members or the two members and any additional intermediate members being integrally formed as a single unitary body with one another or with the two members or the two members and any additional intermediate members being attached to one another.

References herein to the positions of elements (e.g., “top,” “bottom,” “above,” “below,” etc.) are merely used to describe the orientation of various elements in the FIGURES. It should be noted that the orientation of various elements may differ according to other exemplary embodiments, and that such variations are intended to be encompassed by the present disclosure.

In those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that typically a disjunctive word and/or phrase presenting two or more alternative terms, whether in the description, claims, or drawings, should be understood to contemplate the possibilities of including one of the terms, either of the terms, or both terms unless context dictates otherwise. For example, the phrase “A or B” will be typically understood to include the possibilities of “A” or “B” or “A and B.”

What is claimed is:

1. A light fixture comprising:
a frame comprising:
one or more panels;
a first end cap coupled to the one or more panels, the first end cap defining a first end of the frame; and
a second end cap coupled to the one or more panels, the second end cap defining a second end of the frame opposite the first end, wherein at least one of the one or more panels, the first end cap, and the second end cap at least partially define a receptacle; and
a modular driver assembly comprising:
a lighting element; and
a mounting panel configured to selectively interface with the first end cap and the second end cap to support the modular driver assembly within the receptacle defined by the frame.

2. The light fixture of claim 1, wherein the modular driver assembly further comprises a driver coupled to the mounting panel and the lighting element, wherein the driver and the lighting element are simultaneously removable from the frame with the mounting panel.

3. The light fixture of claim 2, wherein the modular driver assembly further comprises a lens positioned to cover the lighting element.

4. The light fixture of claim 3, wherein the first end cap comprises a latch assembly including a latch configured to selectively interface with the mounting panel of the modular driver assembly, wherein the latch assembly is selectively reconfigurable between (a) an engaged position whereby the latch interfaces with the mounting panel to support the modular driver assembly at the first end cap and (b) a disengaged position whereby the latch does not interface with the mounting panel.

5. The light fixture of claim 4, wherein the latch assembly further comprises a resilient member configured to bias the latch towards the engaged position, wherein the first end cap further comprises an aperture, and wherein the latch at least selectively protrudes through the aperture.

6. The light fixture of claim 5, wherein the mounting panel defines a cutout positioned to facilitate accessing the latch through the mounting panel.

7. The light fixture of claim 6, wherein the latch assembly further comprises a guide positioned to interface with the first end cap and support the latch.

8. The light fixture of claim 6, wherein the mounting panel comprises (a) a body that defines an axial direction and (b) a projection extending from the body and along the axial direction, wherein the second end cap defines a second aperture configured to selectively receive the projection to support the modular driver assembly at the second end cap.

9. The light fixture of claim 1, further comprising a latch provided at the first end of the frame and a hinge provided at the second end of the frame, wherein the latch and the hinge are configured to cooperate to selectively couple the modular driver assembly to the frame.

10. A modular driver assembly for a light fixture, the modular driver assembly comprising:
a mounting panel comprising:
a first face;
an opposing second face;
a first end; and
an opposing second end;
a lighting element configured to provide illumination from the light fixture, the lighting element coupled to the first face of the mounting panel; and
a driver operatively connected to the lighting element and at least selectively operatively connected to a power source, the driver configured to provide electrical energy to the lighting element from the power source, wherein the driver is coupled to the opposing second face of the mounting panel;
wherein the first end and the opposing second end of the mounting panel are configured to interface with a frame of the light fixture without fasteners to selectively support the mounting panel, the lighting element, and the driver.

11. The modular driver assembly of claim 10, wherein the first end of the mounting panel comprises a projection configured to be received in a slot defined by the frame of the light fixture and wherein the interface between the projection and the slot is configured to support the modular driver assembly in the light fixture.

12. The modular driver assembly of claim 11, wherein the second end of the mounting panel is selectively supported by a latch and wherein the second end comprises a cutout configured to receive an implement for selectively reconfiguring the latch.

13. The modular driver assembly of claim 12, further comprising a grounding panel sandwiched between the mounting panel and the driver such that the driver is separated from the mounting panel by the grounding panel, wherein the grounding panel is configured to provide at least one of the driver and the lighting element with an electrical ground.

14. The modular driver assembly of claim 10, further comprising a lens configured to cover the lighting element, wherein the lens is not coupled to the frame, and wherein the lens comprises the only lens for the light fixture.

15. The modular driver assembly of claim 10, further comprising a dimmer operatively connected to the driver, wherein the dimmer is configured to variably control the electrical energy provided to the lighting element.

16. A method of installing a modular driver assembly as part of a light fixture, the method comprising:
connecting a driver of the modular driver assembly to a power source, the driver configured to provide electrical energy from the power source to a lighting element of the modular driver assembly;
inserting a projection on a first end of the modular driver assembly into a slot in a first end cap of the light fixture;
raising a second end of the modular driver assembly into a receptacle of the light fixture such that a portion of the second end contacts a latch of the light fixture, biasing the latch away from the second end; and
resting the second end on a surface of the latch.

17. The method of claim 16, further comprising:
inserting a hinge of the light fixture into a first mounting bracket;
rotating the light fixture about the hinge towards a second mounting bracket; and
securing the light fixture to the second mounting bracket with a component of the light fixture.

18. The method of claim 16, further comprising uninstalling the modular driver assembly by:
at least partially removing a lens of the light fixture to facilitate accessing the latch with an implement;
moving the latch away from the modular driver assembly with the implement;
removing the modular driver assembly from the light fixture; and
disconnecting the driver from the power source, the modular driver assembly thereafter defining a removed modular driver assembly.

19. The method of claim 18, further comprising installing a new modular driver assembly, wherein the new modular driver assembly is configured to upgrade the light fixture relative to the driver and the lighting element from the removed modular driver assembly.

20. The method of claim 19, wherein installing the new modular driver assembly includes:
connecting a new driver of the new modular driver assembly to the power source, the new driver configured to provide electrical energy from the power source to a new lighting element of the new modular driver assembly;
inserting a projection on a first end of the new modular driver assembly into the slot;
raising a second end of the new modular driver assembly into the receptacle such that a portion of the second end of the new modular driver assembly contacts the latch, biasing the latch away from the second end of the new modular driver assembly; and
resting the second end of the new modular driver assembly on the surface of the latch.
